(19) United States
(12) Patent Application Publication
(10) Pub. No.: US 2009/0145616 A1
(43) Pub. Date: Jun. 11, 2009

(54) GROUND ENGAGING TOOL BLADE

(75) Inventor: Richard B. BUXTON, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: BLACK CAT BLADES LTD., Edmonton (CA)

(21) Appl. No.: 12/269,379

(22) Filed: Nov. 12, 2008

(30) Foreign Application Priority Data
Nov. 27, 2007 (CA) 2612341

(51) Int. Cl. A01B 13/10; A01B 49/02

(52) U.S. Cl. 172/192; 172/193

(57) ABSTRACT

A modular ground engaging assembly having teeth with inserts. The teeth have a pointed forward prow and a trailing rib that in combination provide an improved cutting surface having relatively lower drag than comparable prior art grader tools.

### FIELD OF THE INVENTION

The present invention relates to a ground-engaging tool with a wear-resistant insert.

### BACKGROUND

Grader tools using hardened insert cutting edges are commonly used in various earth grading applications. It is widely known to use tungsten carbide inserts on the cutting edge of a grader tool. A continuous cutting edge with tungsten carbide inserts is known to work well on flat surfaces or in loose or soft conditions where ground material can be moved, spread or graded, however, it is also known that a discontinuous cutting edge is far superior in performance on hard surfaces such as frozen ground, ice or highly compacted material.

Penetration of the surface is a continuous problem with grading operations in hard, compacted or frozen conditions. Furthermore, constant penetration in hard, compacted or frozen conditions exacerbates wear of the tips.

There is a need in the art for improved tools which may mitigate the disadvantages of the prior art.

### SUMMARY OF THE INVENTION

In one aspect, the invention comprises a modular ground engaging tool assembly, having:

(a) a body defining at least one tooth, wherein said tooth comprises a forward surface, a trailing surface, and a bottom surface;

(b) a wear-resistant insert adapted to engage the forward surface of the body, the insert comprising a bottom surface, a top surface, a forward surface and a back surface;

wherein the body and the insert combine to produce a ground-engaging surface comprising a forward prow and trailing rib.

In one embodiment, the forward prow comprises a point formed by the intersection of two substantially planar or concave surfaces. In one embodiment, the wear-resistant insert comprises tungsten carbide or other wear resistant materials. In one embodiment, the bottom surface of the body is angled away from the bottom surface of the insert, prior to use. In one embodiment, the back and top surfaces of the insert engage the forward surface of the body. In another embodiment, the bottom surface of the insert is angled away from the bottom surface of the tooth towards the ground. In one embodiment there is a plurality of stacked inserts and the back surfaces of the inserts and the top surface of the insert at the top of the stack engage the forward surface of the body. In one embodiment the body defines a plurality of openings for the attachment of the assembly to a vehicle.

In another aspect, the invention comprises a modular ground engaging tool assembly, having:
(a) a body defining at least one tooth, wherein said tooth comprises:
(i) a bottom surface:
(ii) a forward surface, the forward surface defining a pointed forward prow; and
(iii) a trailing surface, said trailing surface defining a rib;
   wherein a portion of the forward surface is comprised of a wear-resistant insert mounted on the body and wherein the forward prow and the rib collectively form a ground engaging surface.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a front view of a tool assembly of the present invention.

FIG. 2 is a cross-sectional view of the embodiment of FIG. 1 along line A-A.

FIG. 3 is a side view of the embodiment of FIG. 1.

FIG. 4 is a front view of the body of the present invention.

FIG. 5 is a cross sectional front view of the embodiment of FIG. 4.

FIG. 6 is a cross sectional side view of the embodiment of FIG. 4.

FIG. 7 is a cross sectional rear view of the embodiment of FIG. 4.

FIG. 8 is a diagrammatic depiction of a carbide insert of one embodiment of the present invention.

FIG. 9 is a cross sectional top view of the embodiment of FIG. 8.

FIG. 10 is a cross sectional front view of the embodiment of FIG. 8.

FIG. 11 is cross sectional side view of the embodiment of FIG. 8.

### DETAILED DESCRIPTION OF PREFERRED EMBODIMENTS

The present invention relates to ground engaging tool assembly. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

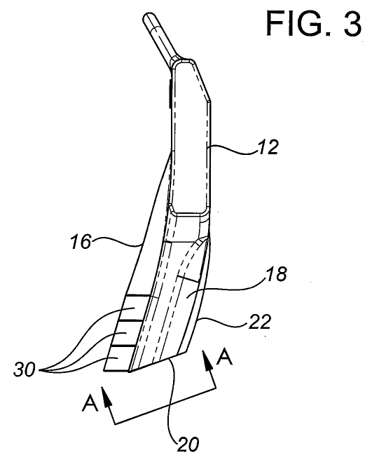

The present invention comprises a modular ground tool assembly (10) for use in grading and ground scraping activities. The assembly (10) has body (12) that defines at least one tooth (14). As depicted in the figures, in one embodiment, the body (12) defines three teeth. The body (12) may be made from any suitable metal including, without limitation, steel. In one embodiment, the body (12) is cast and heat treated to increase strength and durability. Each tooth (14) has a forward surface (16), an opposing trailing surface (18) and a bottom surface (20). The forward surface (16) has a space (17) to accommodate at least one wear-resistant insert (30). As shown in FIGS. 3 and 7, the trailing surface (18) defines a trailing rib (22) extending out and away from the trailing surface (18). An advantage of the implementation of the trailing rib (22) is the ability to reduce the mass of the assembly (10) without reducing its strength. A further advantage relates to the improved flow of displaced material about the trailing rib (22) during grading activities reducing frictional drag of the assembly through the ground.

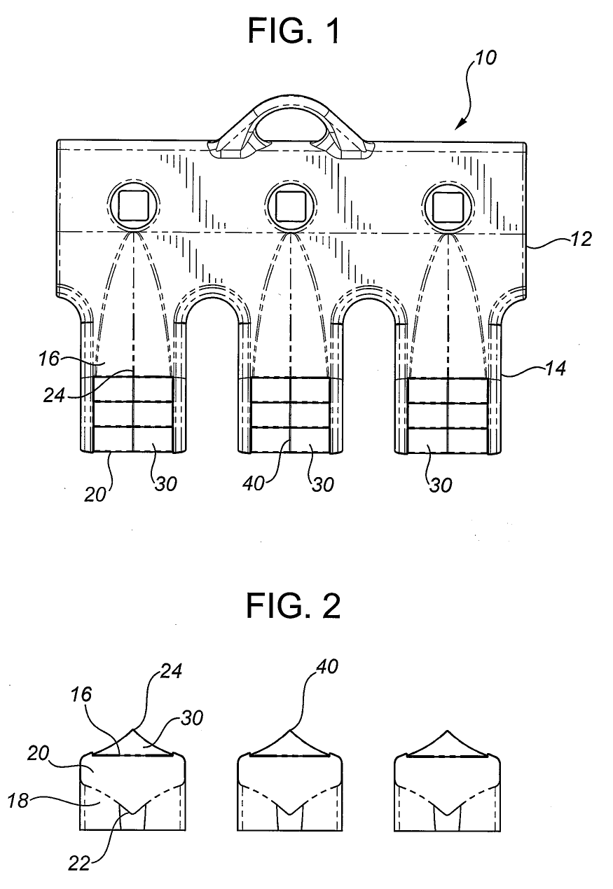

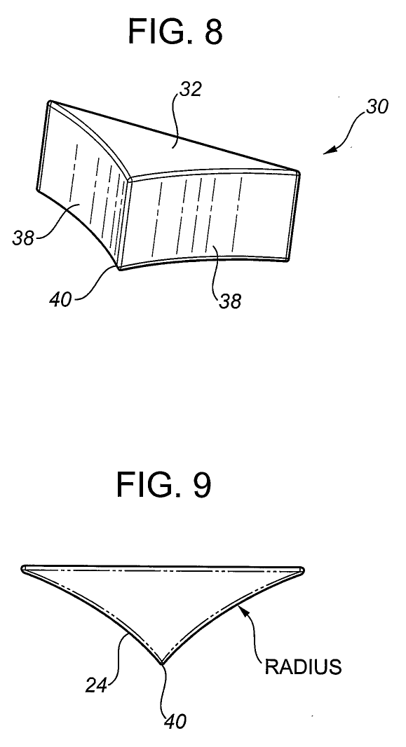

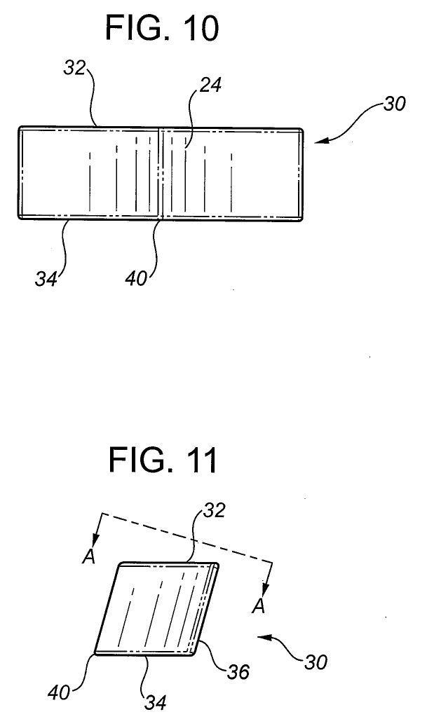

The wear resistant insert (30) shown in FIGS. 8-11, has a bottom surface (34), and upper surface (32), a forward surface (38) and a back surface (36). The insert (30) is adapted to engage the forward surface (16) of the body (12). The assembly (10) may use a single insert (not shown in the Figures), or as depicted in FIG. 1, a plurality of inserts (30) may be used in a stacked configuration. Although a single unitary insert may be used, but a plurality of inserts may offer the advantage of being more resistant to fracture. As shown in FIG. 3, once mounted on the forward surface (16), the back surface (36) of each insert (30) is parallel to, and rests against the forward surface (16) of the body (12). The upper surface of the insert (32) engage a shoulder (19) defined by the forward surface (16). The shoulder (19) assists in the retention of the inserts (30) preventing upwards dislocation of the insert, or inserts as the case may be, during grading operations. It can be understood that if a stack of inserts is being used, then the upper surface (32) of the insert at the top of the stack will engage the shoulder (19) of the forward surface (16). In one embodiment, the inserts are brazed to the forward surface (16), and also to the adjoining surfaces of adjacent inserts. Other means of fastening the inserts to the body may be used, such as mechanical fasteners such as bolts. Each insert (30) may be made from any suitable wear-resistant material or layered materials that would be selected by one skilled in the art. In a preferred embodiment, the insert comprises tungsten carbide.

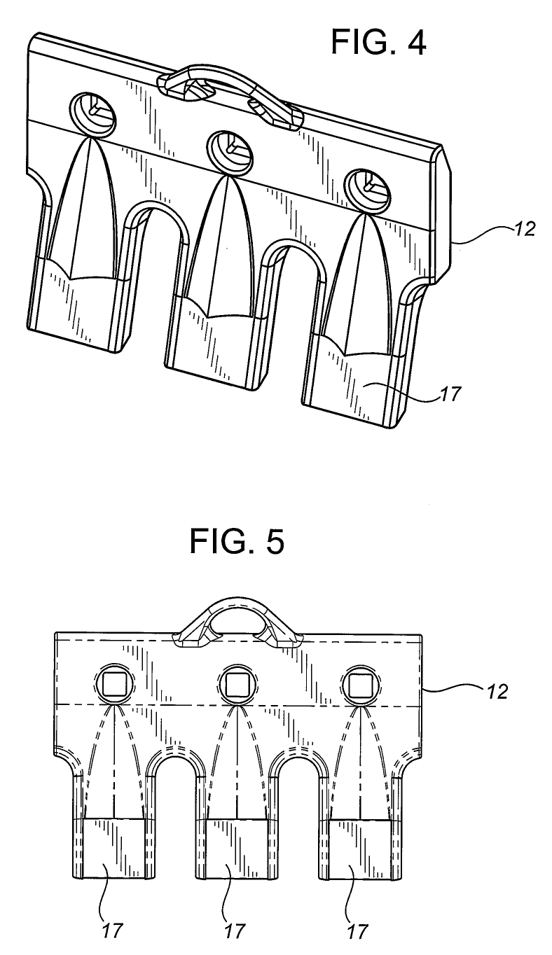

As seen in FIGS. 1 and 3, the forward surfaces (38) of the insert and a raised portion of the forward surface (16) of the body (12) combine to create a unitary forward prow (24) having a point (40). The point (40) may be created by the intersection of two planar surfaces, or by the intersection of two concave surfaces as shown in FIGS. 2, 4, 8 and 9.

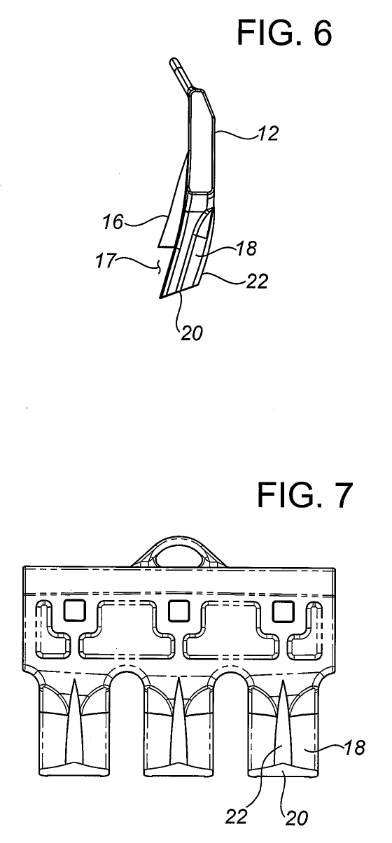

As shown in FIGS. 3 and 6, the bottom surface (20) of each tooth (14) is angled up and away from the bottom surface (34) of the insert. Further, when the insert (30) is mounted on the forward surface (16) of the body (12), the actual insert (30) itself is also angled down towards the ground as shown in FIG. 3. Consequently, the initial point of contact for the assembly (10) with the ground at the commencement of grading activity is the point (40) of the insert, at a position proximate to the bottom surface (34) of the insert (30). This angled configuration of the bottom surface (20) of the tooth (14) and the insert (30) is maintained during grading operations as the assembly (10) moves down and through the ground. The orientation and shape of the insert (30) and of the forward and trailing surfaces (16, 18) of the body (12) are beneficial for a number of reasons.

First, contact by the point (40) of the insert (30) with the ground, and the pointed shape of the forward prow (24) results in cutting action, not a dragging action thereby improving the efficiency of the assembly (10) relative to prior art grader tools. The relatively small footprint of the forward prow (24) and the trailing rib (22) also reduces frictional drag during forward movement of a tooth (14) through the ground again improving the efficiency of the assembly (10). A pointed forward prow (24) created by the intersection of concave surfaces as shown in the figures, also improves the flow of material around the tooth (14) as it moves forward through the ground reducing drag and improving cutting efficiency, and improving downward penetration into the ground.

The angled orientation of the insert (30) and the resulting friction from the ground results in a self sharpening of the inserts (30) as they wear down. The angled orientation of the insert (30) also results in even wearing across the width of the insert (30) maximizing the life span of the same. The tungsten carbide insert (30) will eventually wear down, but it greatly extends the life of the relatively softer metal body (12).

As seen in FIGS. 1, 4, 5 and 7, in one embodiment the assembly further defines openings (25) for attachment to a vehicle such as a grader. Shafts (not shown) are inserted through the openings (25) and locking bolts, or other suitable attachment means, are then employed to secure the assembly onto the shafts. The body also defines a handle (27) that can be used to lift and maneuver the assembly during installation and removal operations. For example, a hook on the end of a chain attached to hydraulic arm may be secured to the handle (27) of the body (12) to lift the assembly (10) from the ground onto the mounting assembly of a grader.

What is claimed is:

1. A modular ground engaging tool assembly, comprising:
(a) a body defining at least one tooth, wherein said tooth comprises a forward surface, a trailing surface, and a bottom surface;
(b) a wear-resistant insert adapted to engage the forward surface of the body, the insert comprising a bottom surface, a top surface, a forward surface and a back surface;
wherein the body and the insert combine to produce a ground-engaging surface comprising a forward prow and trailing rib.

2. The tool assembly of claim 1 wherein the forward prow comprises a point formed by the intersection of two substantially planar or concave surfaces.

3. The tool assembly of claim 1 wherein the wear-resistant insert comprises tungsten carbide.

4. The tool assembly of claim 1 wherein the bottom surface of the body is angled away from the bottom surface of the insert, prior to use.

5. The tool assembly of claim 1 wherein the back and top surfaces of the insert engage the forward surface of the body.

6. The tool assembly of claim 1 wherein the bottom surface of the insert is angled away from the bottom surface of the tooth towards the ground

7. The tool assembly of claim 1 comprising a single insert or a plurality of stacked inserts.

8. The tool assembly of claim 7 wherein the back surfaces of the inserts and the top surface of the insert at the top of the stack engage the forward surface of the body.

9. The tool assembly of claim 1 wherein the body defines three teeth.

10. The tool assembly of claim 1 wherein the body further defines a plurality of openings for the attachment of the assembly to a vehicle.

11. A modular ground engaging tool assembly, comprising:
(a) a body defining at least one tooth, wherein said tooth comprises:
(i) a bottom surface;
(ii) a forward surface, the forward surface defining a pointed forward prow;
(iii) and a trailing surface, said trailing surface defining a rib;
(b) wherein a portion of the forward surface is comprised of a wear-resistant insert mounted on the body and wherein the forward prow and the rib collectively form a ground engaging surface.
